(19) United States
(12) Patent Application Publication
(10) Pub. No.: US 2015/0120929 A1
(43) Pub. Date: Apr. 30, 2015

(54) METHOD FOR PRACTICING RECIPROCITY OF RESOURCES

(71) Applicant: SHENG-CHUN LIN, New Taipei City (TW)

(72) Inventor: SHENG-CHUN LIN, New Taipei City (TW)

(21) Appl. No.: 14/066,714

(22) Filed: Oct. 30, 2013

(51) Int. Cl. H04L 29/08

(52) U.S. Cl. CPC H04L 67/1078
USPC 709/226

(57) ABSTRACT

The present invention relates to a method for practicing reciprocity of resources, which is a method for acquiring resources privilege of future information communication through sharing information communication resources, wherein at least one information device, including a first information device and a second information device, is installed with communication platform software. The first information device and the second information device are set in information connection with each other. When the first information device uses information communication resources through the second information device, resources privilege stored in a first account of the first information device is consumed. Oppositely, when the first information device provides information communication resources to be used by the second information device, the resources privilege of the first account of the first information device is increased so that reciprocity of network resources is achieved with such a process.

### (a) TECHNICAL FIELD OF THE INVENTION

The present invention generally relates to a method for controlling the use of information communication resources by means of resources privilege, and more particularly to a method for practicing reciprocity of resources for mutually beneficial operation of network resources.

### (b) DESCRIPTION OF THE PRIOR ART

Due to the convenience of use and operation, wireless networking has become a part of the regular living so that a user may use a mobile information device, together with the support of a telephone company, to do web surfing at any time and any place for handling daily business thereby greatly improving living standard.

Such a novel way of living, however, causes certain problems, such as insufficiency and waste of network resources. Due to certain considerations, some consumers might take communication solutions that are provided by the telephone companies for network access at fixed information flowrates for given periods of time (such as a solution of 500 MB/month based on the amount of packets used). When the preset amount is exceeded, different situation may occur. For example, the privilege of access may be closed so that the consumers are no longer allowed for network access, or additional fee will be charged. Under this situation, consumers who have need for further surfing of networks must seek for other solutions for use of network resources (such as free Wi-Fi or sharing network resources with other consumers).

In a different situation, which is opposite to what described above, some consumers take a contract with telephone companies for unlimited use of network access so that the consumers are totally free to use the network resources. Under this situation, any time when the consumers are not surfing the networks, such as taking a bath, becomes a kind of waste of the resources. Such a situation and such kind of contract are generally a consequence of the consumers taking into consideration of their own habits of network surfing and low unit price of the resources supplied by the telephone companies. When most of the consumers take such a kind of communication solution of unlimited use, the telephone companies will suffer insufficiency of capacity of hardware and eventually, low quality of communication will result for all the consumers, such as connection interruption and network jamming.

### SUMMARY OF THE INVENTION

The primary object of the present invention is that at least one information device, including a first information device and a second information device, is installed with the communication platform software and information connection is established therebetween so that when there is a change (such as being shared or being lent) occurring in the information communication resources of the first information device and the second information device, the resources privileges of the first account and the second account will be subjected to corresponding changes, whereby with such a technique, the problem of insufficiency and waste of network resources can be overcome and a practical advantage of reciprocity of network resources can be achieved.

The present invention provides a method for acquiring resources privilege of future information communication through sharing information communication resources, wherein at least one information device, including a first information device and a second information device, is installed with communication platform software. The first information device and the second information device are set in information connection with each other. When the first information device uses information communication resources through the second information device, resources privilege stored in a first account of the first information device is consumed. Oppositely, when the first information device provides information communication resources to be used by the second information device, the resources privilege of the first account of the first information device is increased so that reciprocity of network resources is achieved with such a process and the information communication resources can be used in a more efficient manner.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a general architecture of a preferred embodiment of the present invention.

FIG. 2 is a schematic view illustrating a first application of the preferred embodiment of the present invention.

FIG. 3 is a flow chart demonstrating the first application of the preferred embodiment of the present invention.

FIG. 4 is a schematic view illustrating a second application of the preferred embodiment of the present invention.

FIG. 5 is a flow chart demonstrating the second application of the preferred embodiment of the present invention.

FIG. 6 is a schematic view illustrating a third application of the preferred embodiment of the present invention.

FIG. 7 is a schematic view illustrating a fourth application of the preferred embodiment of the present invention.

FIG. 8 is a schematic view illustrating a fifth application of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

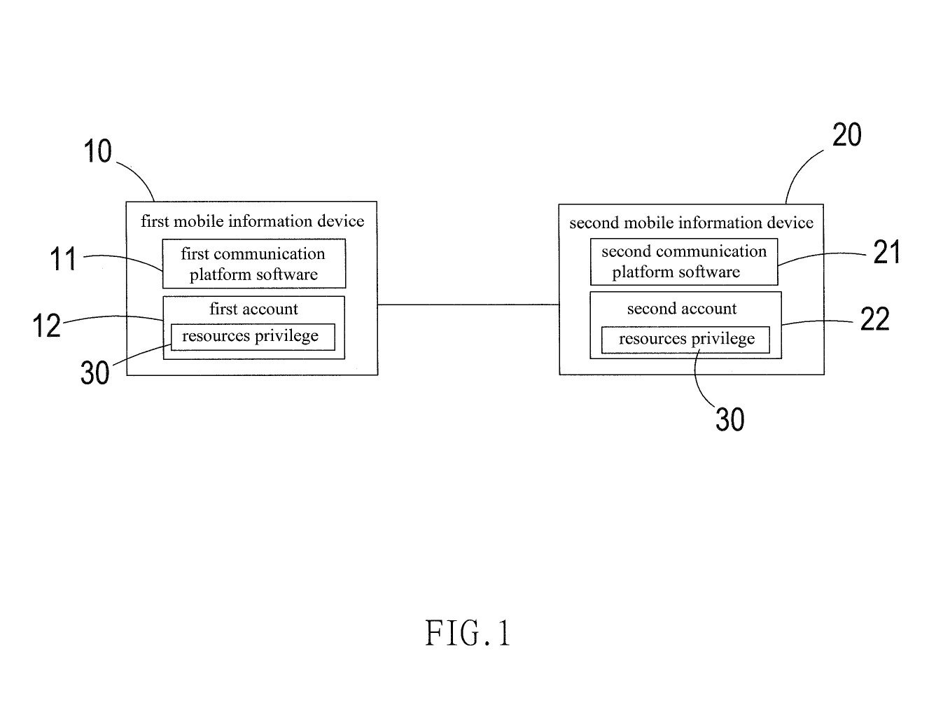

Referring to FIGS. 1-8, which are respectively a schematic view showing a general architecture of a preferred embodiment of the present invention, a schematic view illustrating a first application of the preferred embodiment of the present invention, a flow chart demonstrating the first application of the preferred embodiment of the present invention, a schematic view illustrating a second application of the preferred embodiment of the present invention, a flow chart demonstrating the second application of the preferred embodiment of the present invention, a schematic view illustrating a third application of the preferred embodiment of the present invention, a schematic view illustrating a fourth application of the preferred embodiment of the present invention, and a schematic view illustrating a fifth application of the preferred embodiment of the present invention, these drawings clearly show that the present invention comprises:
at least one first information device 10, wherein the first information device 10 comprises first communication platform software 11 loaded therein and the first information device 10 contains a first account 12 set up therein;
at least one second information device 20, wherein the second information device 20 comprises second communication platform software 21 loaded therein and the second information device 20 contains a second account 22 set up therein, and the first information device 10 and the second information device 20 are in mutual information link with each other; and
a plurality of resources privileges 30, which is respectively defined in association with the first account 12 and the second account 22 to provide cooperative operations corresponding to the information link between the first information device 10 and the second information device 20.

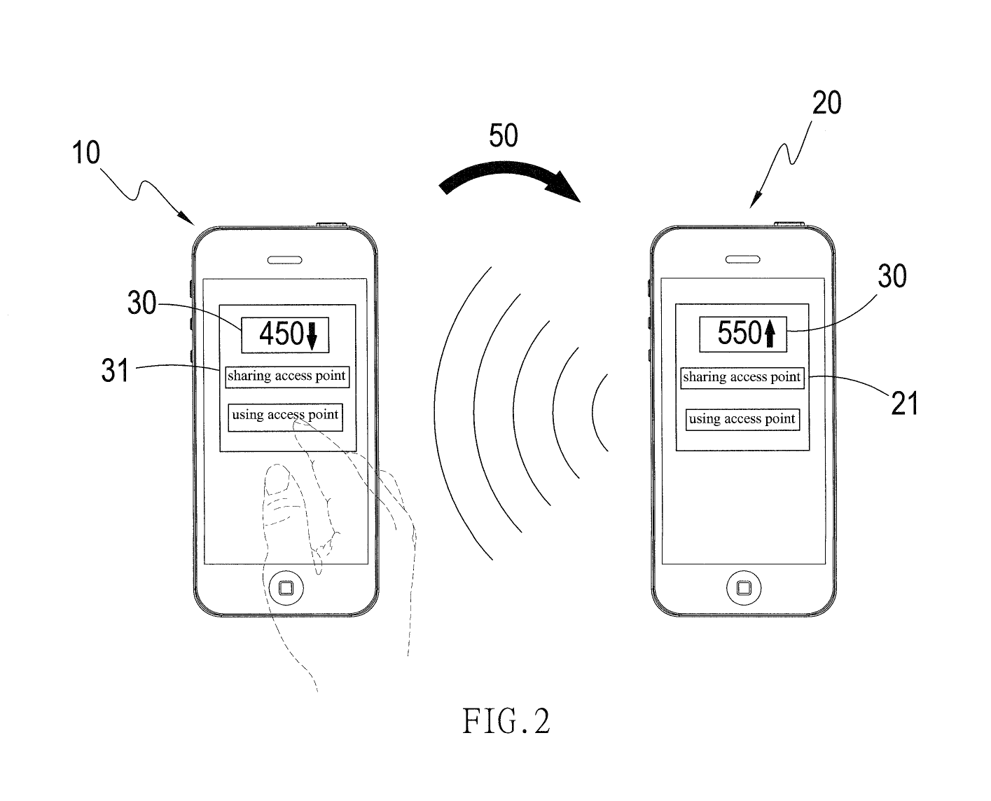

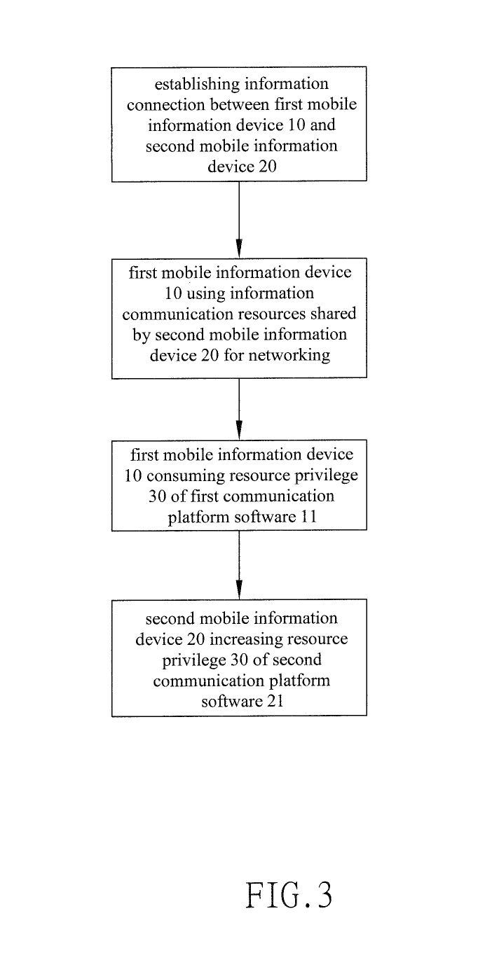

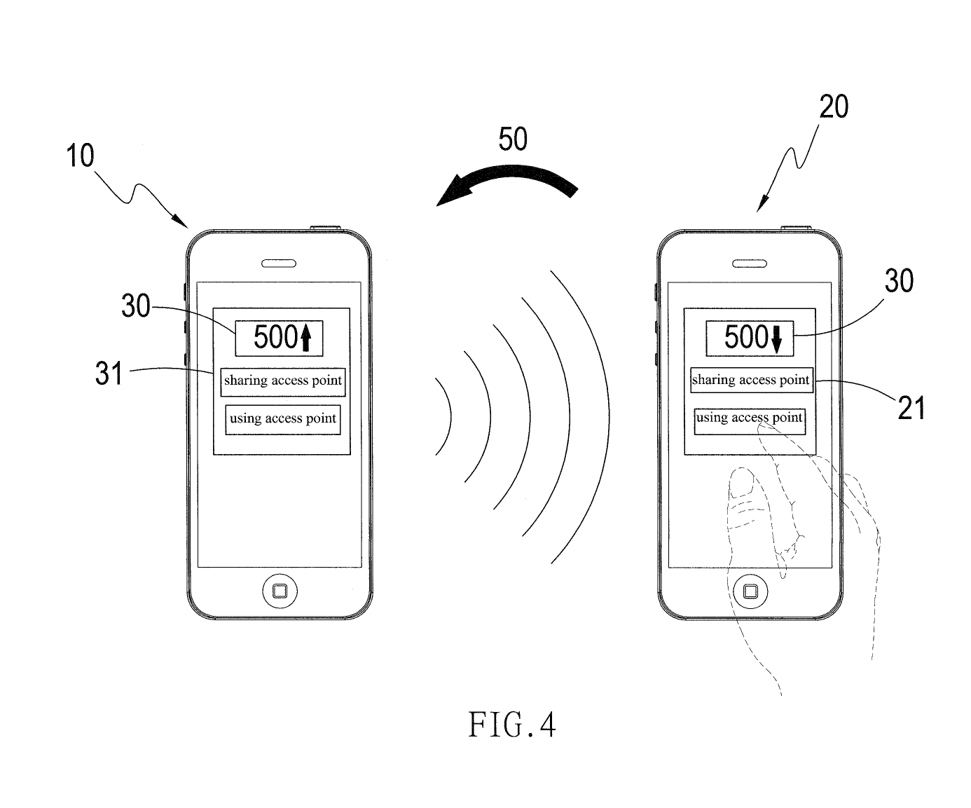

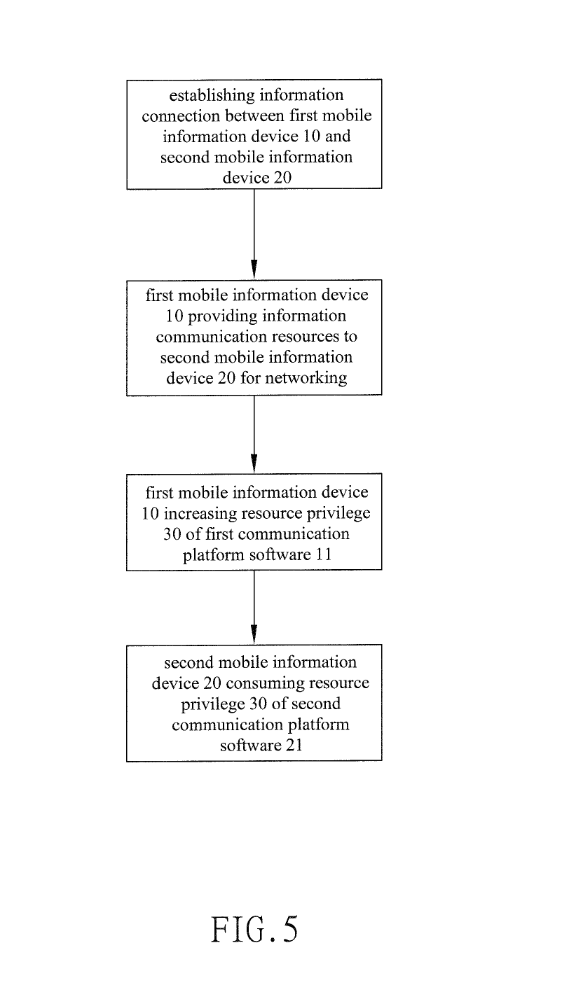

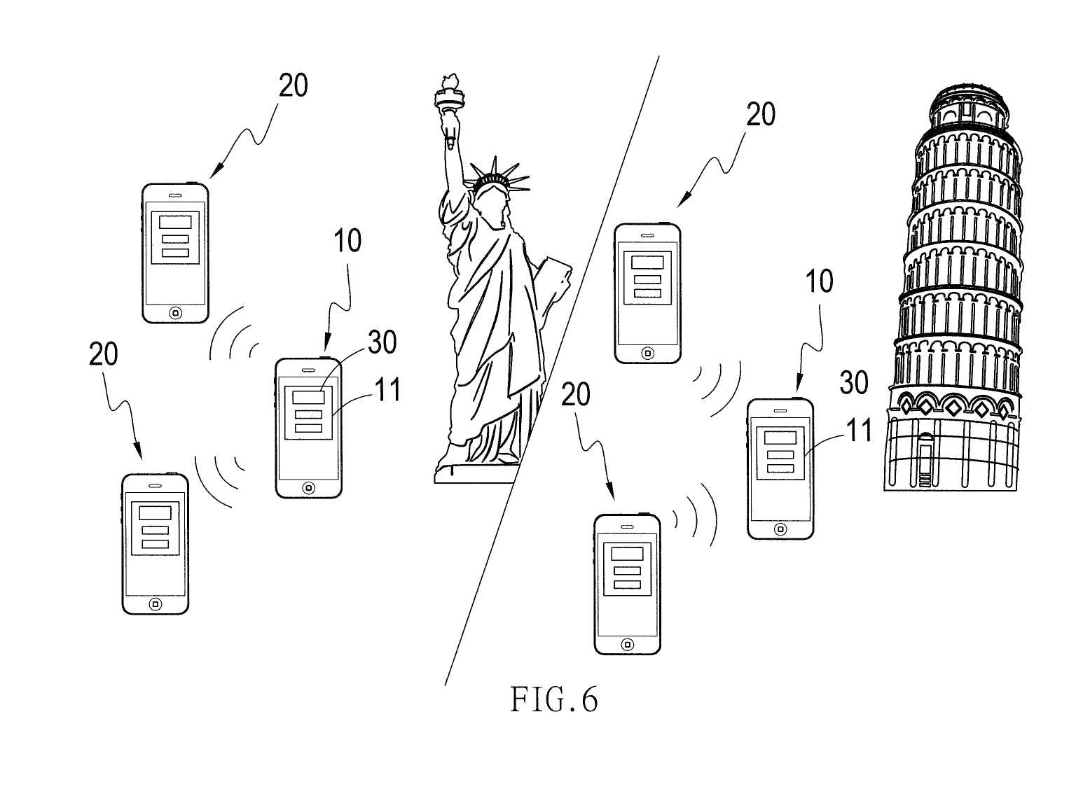

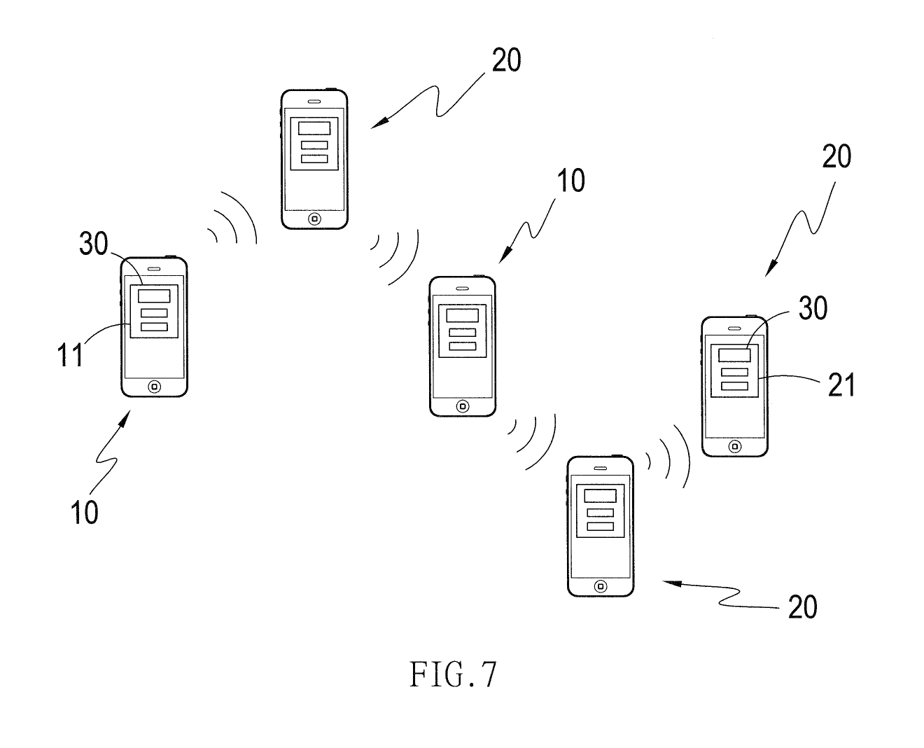

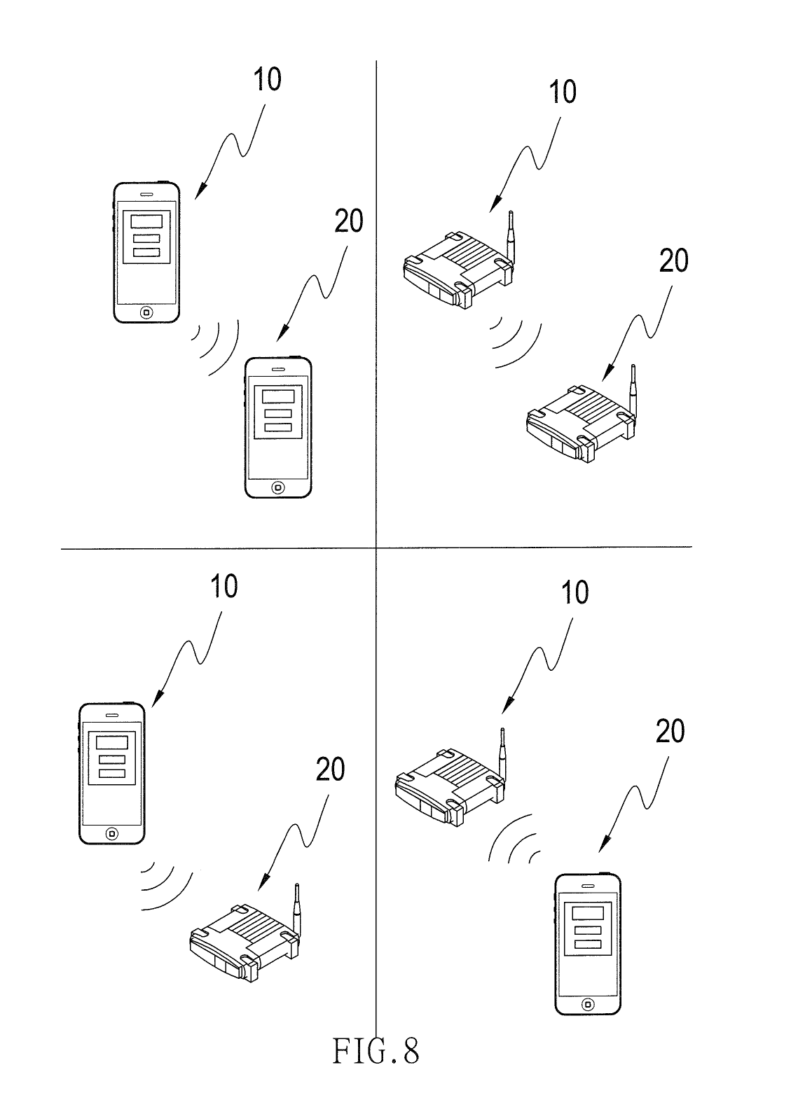

With the above-described arrangement, reference is now made to the drawings to further expound and understand the purpose of the present invention. As shown in FIGS. 2 and 3, an example of application of using information communication resources by means of another person is given. In an attempt to use information communication resources, the first information device 10 establishes connection with the second information device 20 that is located nearby via the first communication platform software 11 so as to set the first information device 10 and the second information device 20 in information connection. Then, the first information device 10 carries out network surfing through the information communication resources provided by and shared with the second information device 20. During the operation, the resources privileges 30 associated with the first communication platform software 11 and the second communication platform software 21 are subject to corresponding changes. In the instant example of application, the first information device 10 is the demand side and thus, the resources privilege 30 of the first account 12 is consumed, while the second information device 20 is the supply side and thus, the resources privilege 30 of the second account 22 is increased. Referring to FIGS. 4 and 5, an example of application of supplying information communication resources to be used by another person. As described above, in the instant example of application, the first information device 10 becomes the supply side, while the second information device 20 is the demand side. The first information device 10 and the second information device 20 first set up information connection with each other and then, the first information device 10 supplies information communication resources to be used by the second information device 20 so that the second information device 20 is allowed to complete networking. During the process, the resources privilege 30 of the first account 12 will be increased, while the resources privilege 30 of the second account 22 will be consumed and decreased. Thus, with such a mechanism, information communication resources can be used in a more efficient manner and hardware and load of circuit and lines of the telephone company can be properly balanced. Referring to FIG. 6, an application is shown to apply the mechanism to improve the current problems, wherein a user who, in a domestic area, has long shared the information communication resources of the first information device 10 to be used by the second information device 20 of another person and this results accumulation of a large amount of resources privilege 30 in the first account 12. The resources privilege 30 so accumulated in the first account 12 by means of the consumption of the information communication resources of the second information device 20 can be then used, through such a mechanism, later when the user travels in a foreign area. As such, the problem that the user may bear a large amount of service charge caused by the wiring resources of the telephone companies being not internationalized can be improved and also, the non-regular loading of resources can be reduced. Referring to FIG. 7, an application is shown to apply the mechanism to improve the current problems, wherein when a large number of first information devices 10 and second information devices 20 are simultaneously put into operation, a huge network of reciprocity of information communication resources is formed, wherein two users located at remote end sites can be such that one of the users is a supplier of information communication resources, while the other is a demander of information communication resources. In such a huge network of reciprocity of information communication resources, the other users involved in the network each play a role of a mobile hot spot. The change/increase/decrease of the resources privilege 30 only occurs at the two end-site users, while the intervening users of mobile hot spots are not subject to such change thereby achieving the advantage and purpose of greatly expanding the coverage of information communication resources. Referring to FIG. 8, with such a mechanism and method, it is possible to further expand the application to sharing and reciprocity and alternative ways of use of the network resources, wherein the first information device 10 and the second information device 20 can be mobile device or fixed network access points and thus, four combinations can be achieved (of which the four modes of application are respectively mobile device vs. mobile device, mobile device vs. fixed network access point, fixed network access point vs. mobile device, and fixed network access point vs. fixed network access point). This indicates the importance of an account mechanism (which allows an information device to enter the reciprocity of information communication resources through a corresponding account). Such a mechanism and method takes advantage of the cooperation between the first communication platform software 11 and the second communication platform software 21 to overcome the problem of hardware compatibility and thus achieving the reciprocity network information communication resources described above. Further, besides acquiring resources privilege 30 through sharing information communication resources, acquirement can be made through alternative ways, such as being transferred from the first account 12, in a free and priceless manner, to the second account 22 (namely being given between users in a mutual manner). Alternatively, resources privilege 30 can be obtained through purchasing (such as directly purchasing from a company running and hosting such a mechanism). It will be further described the importance of and services supplied by a company that runs and hosts such a mechanism and a way of operation that is different from what described above, wherein the first information device 10 is a fixed network access point and the second information device 20 is a mobile device. The first information device 10 supplies information (such as point name and code) necessary for connection to the operation company or application of the hot point name and code can be made to the operation company to allow for management by the operation company, wherein in a real condition, there will be a situation of a large number of suppliers and first information devices 10 being identical and also a situation of a large number of demanders and second information devices 20 being identical. When the second information devices 20 attempt to use the information communication resources supplied by the first information devices 10, the second information devices 20 use the second communication platform software 21 to carry out computation on the hot point name so as to obtain the associated code, or alternatively, the second information device 20 can be connected to the operation company to acquire the hot point name and code of the first information device 10. Similar to the above situations, when the second information device 20 is put into operation, the operation company takes the resources privilege 30 away from the second account 22 for being fed to the first account 12 (this example being an application where a first user has two first information devices 10, respectively serving as a fixed network access point and a mobile device, so that the fixed network access point supplies information communication resources and the mobile device receives and acquires the resources privilege 30). In case of malignant operations (such as invasion and damage), the intervention of the operation company may help stop or cut off the operation in a compelling manner. This clearly shows that the management and control and monitoring of the resources privilege 30, as well as full control of the mechanism, can be realized with the operation company so as to provide the mechanism with improved flexibility of use to thus achieve total use thereof. As such, the method that allows for acquirement of resources privilege for future information communication through sharing of information communication resources in a manner of reciprocity of network resources can effectively improve the problems of insufficiency and waste of network resources and can also improve the inconvenience occurring in the contemporary environments to achieve the advantage and purpose of reciprocity of network resources.

The features that the method for practicing reciprocity of resources according to the present invention improves the prior art are as follows:

Resources privilege 30 are provided to help achieving reciprocity of information communication resources and also improving the situation of insufficiency and waste of network resources, so that the loading of the hardware of the telephone company can be reduced and an advantage of greatly increasing coverage of information communication resources can be achieved to completely realize the purpose of reciprocity of network resources.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for practicing reciprocity of resources, which is a method for acquiring resources privilege of future information communication through sharing information communication resources, wherein at least one information device, including at least one first information device or at least one second information device, is installed with communication platform software, the first information device being provided with a first account, the second information device being provided with a second account, the first information device and the second information device being set in information connection with each other, whereby when the first information device uses information communication resources through the second information device, resources privilege stored in the first account of the first information device is consumed and when the first information device provides information communication resources to be used by the second information device, the resources privilege of the first account of the first information device is increased so that reciprocity of network resources is achieved with such a process.

2. The method for practicing reciprocity of resources according to claim 1, wherein the communication platform software comprises an application (APP).

3. The method for practicing reciprocity of resources according to claim 1, wherein the resources privilege have a unit of packet or time of operation.

4. The method for practicing reciprocity of resources according to claim 1, wherein the information communication resources comprises one of network information flow, voice communication, and video and audio sources.
